(19) United States
(12) Patent Application Publication
(10) Pub. No.: US 2009/0058047 A1
(43) Pub. Date: Mar. 5, 2009

(54) Multi-purpose wheelbarrow

(75) Inventors: Atar Brosh, Tel Aviv (IL); Yehoyada Beeri, The Old City Jerusalem (IL); Ehud Ben Avi, D.N. Emek Yizrael (IL); Liran Elbaz, Tel Aviv (IL); Zvika Zak, Herzelia (IL); Tomer Levin, Kfar Saba (IL)

Correspondence Address: THE NATH LAW GROUP, 112 South West Street, Alexandria, VA, 22314, US

(73) Assignee: KETER PLASTIC LTD, Herzelyia (IL)

(21) Appl. No.: 12/230,380

(22) Filed: Aug. 28, 2008

Related U.S. Application Data
(60) Provisional application No. 60/935,771, filed on Aug. 30, 2007.

(51) Int. Cl. B62B 1/00

(52) U.S. Cl. 280/653

(57) ABSTRACT

According to one aspect of the present invention, there is provided a wheelbarrow comprising a storage unit, and a wheel assembly associated with the storage unit and having at least one wheel of a predetermined diameter. The wheelbarrow further comprises at least one gripping member, also associated with the storage unit, and adapted for manipulation of the wheelbarrow by an operator. The storage unit is formed with at least one wall extending along a direction tangent to the at least one wheel. The wheelbarrow is adapted to assume a first, ‘transport’ position in which the wheelbarrow is transportable about upon the wheel assembly, and a second, ‘L’ position in which the wheelbarrow has an essentially vertical orientation with respect to a surface, in which the wheelbarrow is supported by the wheel assembly and the wall.

This application claims the benefit of prior U.S. provisional patent application No. 60/935,771 filed date 2007, the contents of which are hereby incorporated by reference in their entirety.

### FIELD OF THE INVENTION

This invention relates to wheelbarrows, in particular, wheelbarrows adapted for assuming an L position.

### BACKGROUND OF THE INVENTION

Wheelbarrows are known in the art to provide a convenient way of transporting a desired amount of material or items from one place to another. Common wheelbarrows comprise a storage unit, two gripping handles and a wheel attached to the storage unit, wherein an operator grabbing the handles, may maneuver the wheelbarrow about upon the wheel.

A variety of modification on common wheelbarrow have been suggested in the art in order to provide a more convenient maneuvering thereof, more storage space, means for stable positioning said wheelbarrow on the ground etc.

Also known in the art are hand trucks which typically are L-shaped handcarts with handles at one end, two or more wheels at the base, with a small ledge to set objects on, flat against the floor when the hand-truck is upright. The objects to be moved, typically of regular shape, are tilted forward, the ledge is inserted underneath them, and the objects allowed to tilt back and rest on the ledge. Then the truck and objects are tilted backward until the weight is balanced over the large wheels, making otherwise bulky and heavy objects easier to move.

One such modification is disclosed in GB794752 directed to a wheelbarrow which comprises a pair of side members extending substantially parallel and longitudinally of the wheelbarrow, and a transverse front member, the side members forming handle parts on their rear extremities and being downwardly and forwardly inclined, in the normal upright position of the barrow, from the handle parts to the wheel mounting position, to form rear support parts for the rear wall of the pan of the barrow and beyond that position being upwardly and forwardly inclined to meet the transverse front member with which they form a front support part for the front wall of the pan.

Another modification regarding the capacity of the storage unit is disclose in U.S. Pat. No. 4,109,933 which directed to a folding wheelbarrow which can be constructed so as to utilize a wheelbarrow body which is adapted to be folded or manipulated from a normal position into a folded position. Such a body is attached to a wheel support serving to carry a normal wheel and handles. In order to achieve a satisfactory folding action each such body is constructed so as to have a bottom wall including at least two bottom panels, a front wall having at least two front wall panels and sides connected by the bottom wall panel and the front wall panel. A plurality of separate linkage hinges connect the bottom and front wall panels and the sides so as to permit motion of the panels and the sides during manipulation of the body from a normal position into a folded position. A latch or latch-type structure is preferably used to connect at least two parts which pivot relative to one another during such folding so as to hold the body in its normal position.

Another modification regarding the dual-purpose wheelbarrow is disclosed in U.S. Pat. No. 7,168,712 which is concerned with a multi-function hand truck is convertible to allow lifting of a load at a spaced distance from the truck and/or is convertible for use as a wheelbarrow. A pair of lifting arms co-operate with the frame of the hand truck to extend outwardly therefrom and allow the frame of the hand truck to provide a mechanical advantage for lifting. The wheels of the truck are moveable rearwardly for conversion to a wheelbarrow mode. An open top container is positioned within the frame of the hand truck for receiving material. The multi-function hand truck is efficiently stored in a vertical orientation.

### SUMMARY OF THE INVENTION

According to one aspect of the present invention, there is provided a wheelbarrow comprising a storage unit, a wheel assembly associated with said storage unit and having at least one wheel of a predetermined diameter, and at least one gripping member, also associated with said storage unit, and adapted for manipulation of said wheelbarrow by an operator; said storage unit is formed with at least one wall extending along a direction tangent to said at least one wheel whereby said wheelbarrow is adapted to assume a first, ‘transport’ position in which said wheelbarrow is transportable about upon said wheel assembly, and a second, ‘L’ position in which said wheelbarrow has an essentially vertical orientation with respect to a surface in which said wheelbarrow is supported by said wheel assembly and said wall.

The storage unit may be further formed with a bottom extension adapted to provide support for the wheelbarrow allowing it to assume a third, ‘stationary’ position. In this position, the wheelbarrow may be positioned on a surface without an operator supporting it by said at least one gripping element.

Said storage unit may be formed with a bottom, front and side walls, and may be designed such as to allow nesting of one wheelbarrow within a similar corresponding wheelbarrow, thereby allowing stacking of a plurality of wheelbarrows one on top of the other in a compact manner.

The rim of the wall of said storage unit may be adapted for attachment thereto of a shoveling edge so that in said ‘L’ position, said shoveling edge is in contact with said surface and may be used to scoop a certain amount of material or items positioned on said surface into said storage unit. Alternatively, the shoveling edge may be integrally formed with said storage unit. The shoveling edge may be formed as a wedge, facilitating easier scooping of said material into said storage unit, and may be made of various materials, e.g. plastic, steel, etc. The scooped material/items may be, for example, sand, cement, bricks, etc. Said storage unit may further comprise a barrier wall adapted to prevent said material from falling out of the storage unit when said wheelbarrow is in said ‘L’ position.

The bottom end of said storage unit may be formed with a foot-rest adapted to allow and operator, when said wheelbarrow is in said ‘L’ position, to apply pressure using his foot in order to scoop material into said storage unit. According to a specific embodiment, said foot rest may be constituted by said wheel assembly.

Said storage unit may further comprise a protective cover adapted to protect any material within said wheelbarrow from exposure to rain, environmental damage etc. for example, when transporting the material from one location to another. The protective cover may be detachably attachable to the storage unit and/or be stored away within a pre-designed enclosure of the storage unit. The protective cover may be made of nylon, canvas etc.

According to a specific embodiment, said storage unit may be formed of a first portion and a second portion, hingedly articulated to each other, each portion having a bottom wall, a front wall and at least one side wall extending from said bottom wall. The storage unit may assume a first storage position, i.e. ‘container position’, and a second storage position, i.e. ‘wheelbarrow’ position.

In said container position, the front wall of said first portion may be essentially flush against the front wall of said second portion to form a uniform front surface, the bottom walls of each of the portions being spaced apart by said at least one side wall of each portion. In this position, the two portions of said storage unit may form a container, wherein in said ‘L’ position, said uniform front surface is adapted to support the weight of a material stored within said storage unit. According to a specific embodiment, said container is open at the end opposite said uniform front surface so as to allow top loading of material therein when said wheelbarrow is in said ‘L’ position.

Said storage unit may comprise a securing mechanism adapted to securely connect said first portion to said second portion in order to said container from opening by rotation of one of said portions about the hinge. Said securing mechanism may be in the form of a latch arrangement, snapping arrangement, etc.

The rim of each portion of said storage unit may be formed with a rail and said latch mechanism may be slidable along said rail. Thus, the securing mechanism may also secure the two portions when in the ‘wheelbarrow’ position, for example, by slidingly displacing the latch to the seam line between said first and said second portion, so as to embrace the rim of both portions.

In said wheelbarrow position, the bottom wall of said first portion may be essentially flush against the bottom wall of said second portion to form a uniform bottom surface, the front walls of each of the portions being spaced apart by said at least one side wall of each portion. In this position, the two portions of said storage unit may form an open wheelbarrow storage unit surrounded by the front and side walls of each portion. In a ‘transport’ position, said uniform bottom surface is adapted to support the weight of a material loaded on said storage unit.

Each of the portions may be perforated allowing transport of material requiring circulation of air etc. Said first and/or said second portion may be fitted with a lid adapted to cover the top end of the container at the ‘container’ position. The lid may be articulated to either of said portions, for example, using a hinge. The gripping element may be articulated to the first portion of said storage unit.

According to a specific embodiment, said wheelbarrow may comprise a support frame. Said support frame may be formed of at least one longitudinal bar and at least one transverse bar, adapted to provide support for said storage unit. According to a specific embodiment, said support frame is formed of two longitudinal bars and several transverse bars providing the frame with required rigidity. Each of the two longitudinal bars may be formed with said gripping element. Each of said two longitudinal bars may also be telescopic, allowing the bars to extend so as to provide additional length to the frame when said storage unit is at the ‘wheelbarrow’ position.

Said storage unit may be detachably attachable to/from said support frame. For this purpose, said storage unit may be fitted with at least one hook formed at the bottom wall thereof, whereby said storage unit may be hung on said at least one transverse bar of the support frame. Alternatively, the side and bottom walls of said storage unit may be formed with at least one longitudinal rib adapted to slide within at least one corresponding longitudinal rail formed within said longitudinal bar. This may provide further stability and prevent spontaneous disengagement of said storage unit from said support frame.

The storage unit may also comprise a handle adapted for carrying said storage unit when in said ‘container’ position, thereby transforming it into a portable storage unit module. According to a specific embodiment, said handle may comprise the securing mechanism securing said portions to one another. The handle may also be used for attaching said storage unit to said support frame.

Said support frame may also comprise a back support hingedly articulated to one of said transverse bars and adapted to provide support for the wheelbarrow when in positioned horizontally on said surface in a ‘transport’ position by assuming a position in which it extends between said support frame and said surface. Said back support may have a closed position in which it extends essentially in the direction of the longitudinal bars and an open position in which said back support extends perpendicularly to said frame, whereby, in a ‘transport’ position, said back support assumes the position described above. Said back support may be freely attached to said transverse bar so as to automatically assume its position be gravitational force.

Said support frame may further comprise a rotatable platform hingedly articulated to a bottom transverse bar of said support frame and adapted to be tilted to become essentially perpendicular to said longitudinal axis in order to provide support for said storage unit and/or to various items positioned thereon. In this configuration, the wheelbarrow may be used as a hand truck.

Said platform may be of greater dimension than the front walls of said first and second portions wherein when said storage unit is attached to said support frame, said platform may extend beyond said front wall. In this case, said platform may be provided with a shoveling edge as described previously with respect to said storage unit to provide convenient scooping of material into said storage unit.

The wheel assembly of said wheelbarrow may be formed of two wheels mounted on a mutual axis, said wheels being spaced apart to provide said wheelbarrow with stability during both first and second position. The wheel assembly may be adapted to be detachably attached to the bottom of said storage unit or said support frame. Alternatively, said mutual axis may be integrally formed with said storage unit, wherein said wheels are adapted to be detachably attachable to said mutual axis. This may allow convenient storage of a plurality of wheelbarrows within a predetermined space, e.g. during shipment.

The wheelbarrow may comprise two gripping elements adapted for the hands of an operator, each gripping element being formed with two gripping surfaces angled to each other, a first gripping surface being adapted for gripping in said first position of the wheelbarrow and said second gripping surface being adapted for gripping in said second ‘L’ position. Alternatively, each of said gripping elements may be formed as a closed frame having an inner circumference, and a single gripping surface adapted to be freely displaced along said inner circumference, allowing convenient gripping thereof both in said first ‘transport’ position and in said second ‘L’ position.

According to a specific embodiment of the present invention, said wheelbarrow excluding said wheels, may be made of plastic and formed as a single injection molding element.

According to another aspect of the present invention there is provided a storage unit for a wheelbarrow comprising a first and a second storage unit portions, each portion comprising a bottom wall, a front wall and two side walls, said second portion being articulated to said first portion so as to allow rotation thereof about said first portion about an axis, said storage unit having at least two positions:
a) a container position in which the front wall of said first portion is essentially flush against the front wall of said second portion to form a uniform front surface, the bottom walls of each of the portions being spaced apart by said side walls of each portion to form a container.
b) a wheelbarrow position in which the bottom wall of said first portion is essentially flush against the bottom wall of said second portion to form a uniform bottom surface, the front walls of each of the portions being spaced apart by said side walls of each portion to form wheelbarrow platform.

According to a further aspect of the present invention there is provided a wheelbarrow made of a single injection molding element, said wheelbarrow comprising a storage unit, at least one gripping means and an attachment port for a wheel assembly; said storage unit being formed with at least one wall extending along a direction tangent to said at least one wheel such whereby said wheelbarrow is adapted to assume a first ‘transport’ position in which said wheelbarrow is transportable about upon said wheel assembly, and a second position in which said wheelbarrow has an essentially vertical ‘L’ position in which at least a portion of said wall and said at least one wheel rest one a single planar surface.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a front isometric view of a wheelbarrow according to the present invention;

FIG. 2 is a rear isometric view of the wheelbarrow of FIG. 1;

FIG. 3A is a side view of the wheelbarrow of FIG. 1 when in first, ‘stationary’ position;

FIG. 3B is a side view of the wheelbarrow of FIG. 1 when in a second, ‘transport’ position;

FIG. 3C is a side view of the wheelbarrow of FIG. 1 when in a third, upright L-like position;

FIG. 4A is a bottom isometric view of the wheelbarrow of FIG. 1;

FIG. 4B is a bottom isometric view of the wheelbarrow of FIG. 1 without a wheel assembly;

FIG. 5 is an enlarged view of a gripping element of the wheelbarrow of FIG. 1;

FIG. 6 is an isometric view of another wheelbarrow according to the present invention;

FIG. 7A is a side view of the wheelbarrow of FIG. 6 in a first, ‘stationary’ position;

FIG. 7A is a side view of the wheelbarrow of FIG. 6 in a second, ‘transport’ position;

FIG. 7C is a side view of the wheelbarrow of FIG. 6 in an upright ‘L’ position;

FIG. 8 is an isometric view of the wheelbarrow of FIG. 6;

FIG. 9 is a side view of the wheelbarrow of FIG. 8 when converted into a ‘container’ position;

FIG. 10 is an isometric view of a wheelbarrow according to yet another embodiment of the present invention;

FIG. 11 is an isometric view of the wheelbarrow of FIG. 10 without a storage unit at an upright position; and

FIG. 12 is an isometric view of the wheelbarrow of FIG. 10 without a storage unit at an angled position with deployed support legs.

### DETAILED DESCRIPTION OF EMBODIMENTS

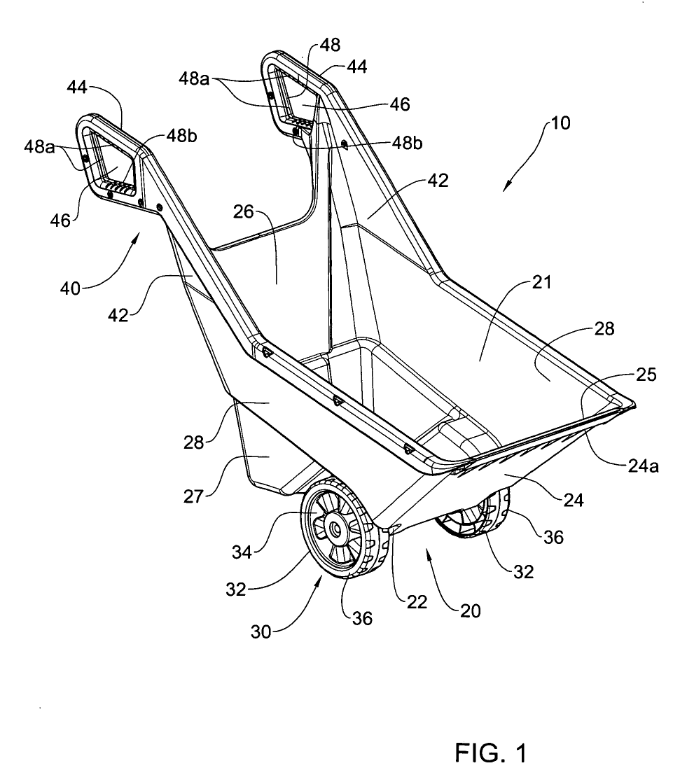

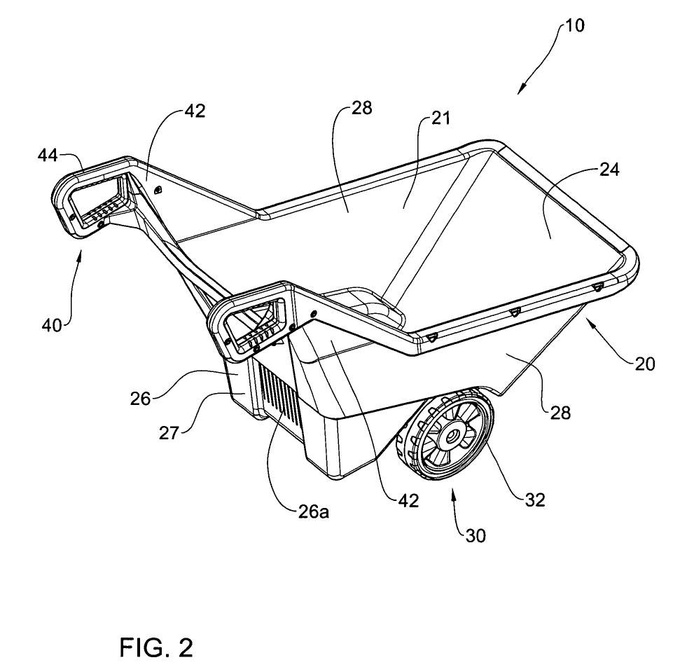

Referring to FIGS. 1 and 2, a wheelbarrow generally designated 10 is shown comprising a storage unit 20, a wheel assembly 30 attached to the storage unit 20, and a handling portion 40 integrally formed with the storage unit 20.

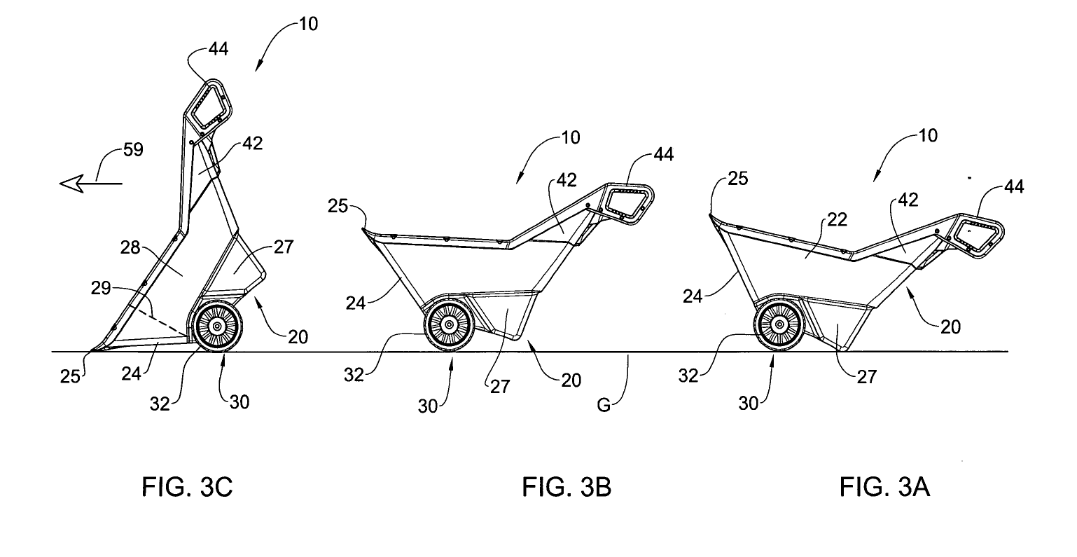

The storage unit 20 is formed of a bottom wall 22, a front wall 24, a rear wall 26 and two side walls 28, defining together a storage space 21 therein. The walls 24, 26 and 28 taper outwardly from the bottom wall 22 so as to allow manufacturing of the storage unit 20 by single injection molding. The tapering of the walls may also facilitate nesting of one wheelbarrow 10 within the storage space 21 of another wheelbarrow 10 allowing convenient stacking of wheelbarrows 10 one on top of the other. A top edge 24a of the front wall 24 is formed with a shoveling edge 25 fitted for scooping/shoveling of material from the ground as will be explained in detail with respect to FIG. 3.

In the present example the shoveling edge 25 is made of metal secured to the edge of the front wall 24, however the shoveling edge may be made of other material e.g. reinforced plastic material.

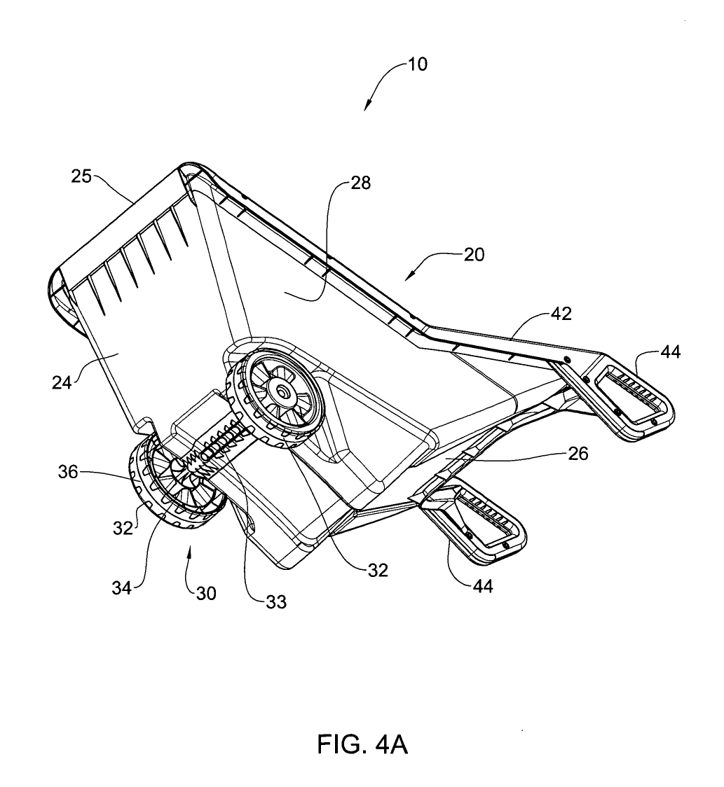

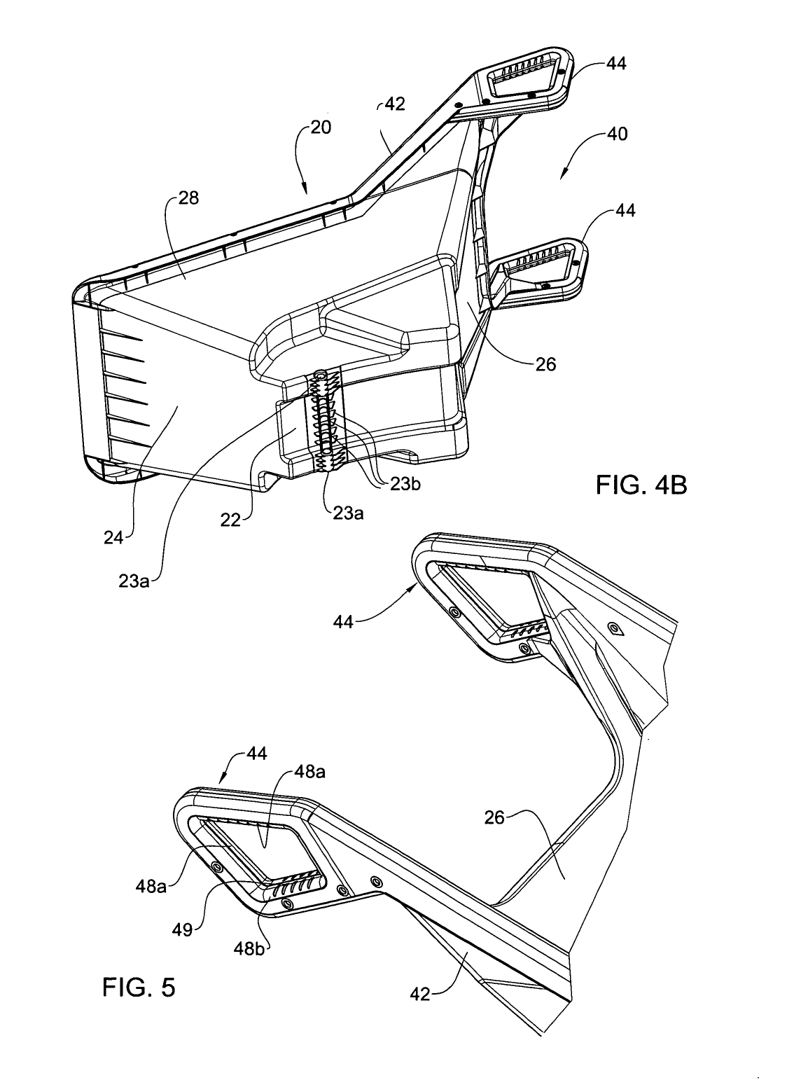

The wheel assembly 30 comprises two wheels 32 mounted on a common axle 33 (shown FIG. 4A), each wheel being formed of a rigid core 34 and a tire 36. The core 34 is made of strong plastic and the tire 36 may be made of rubber or other material, optionally more resilient. However, the core and tire may be integral as well. The common axle 33 is mounted to the storage unit as will be explained with respect to FIGS. 4A and 4B.

The handling portion 40 is formed of two extensions 42 extending upwardly at an angle from the storage unit 20 to serve as handles for the wheelbarrow 10. Each extension 42 is formed at its distal end with a gripping portion in the form of a rectangular handle 44 defining a space 46 therein and having an inside circumference 48. With further reference to FIG. 5, the handle 44 is adapted for the grip of an operator of the wheelbarrow and its inside circumference 48 is formed of two section 48a and 48b the purpose of which will be explained later.

Turning to FIGS. 3A to 3C, the wheelbarrow 10 is shown in several respective positions. At the ‘stationary’ position of FIG. 3A, the wheelbarrow 10 rests on the ground G upon the wheel assembly 32 and on a rear support extension 27 of the storage unit 20, wherein a load may rest securely within the storage unit 20. The extension 27 is hollow and forms part of the storage space 21 of the storage unit 20. Reverting to FIG. 2, the extension 27 extends almost throughout the width of the wheelbarrow 10. Upon nesting, the extension of one wheelbarrow nests within the extension of another wheelbarrow.

At the ‘transport’ position (FIG. 3B), the extension 27 is lifted off the ground G by gripping the handles 44, allowing maneuvering of the wheelbarrow 10 about the ground G upon the wheel assembly 32 alone. When maneuvering the wheelbarrow 10, an operator may conveniently place his hands on the first section 48a of the inside circumference of the handle 44, allowing easy handling of the wheelbarrow 10. Alternatively, the operator may opt to manipulate the wheelbarrow by gripping the handle 44 at its other portions 48b and 49. In the ‘transport’ position, most of the load of the wheelbarrow 10 is evenly distributed and supported by the wheel assembly 30 rather than by the operator, allowing carrying great amounts of material.

At the upright L-like position, the wheelbarrow 10 rests on the ground G supported by the wheels 32 of the wheel assembly 30 and over the front wall 24, resting substantially flush over the ground surface G. The tapering angle of the front wall 24 with respect to the bottom wall 22 is designed such that in the ‘L’ position, it is essentially flush against the ground G.

The shoveling edge 25 formed at the top end 24a of the front wall 24 allows scooping/shoveling a substantial amount of loose material or solid material (not shown) into the wheelbarrow 10 by pushing the wheelbarrow 10 forward against the material. When loading the wheelbarrow 10 with material, the pushing forwards movement may be aided by the operator presenting his foot either on the wheel assembly 30 or on the extension 27. When unloading a loaded wheelbarrow 10, an operator may place his hands on the second gripping section 48b and tilt the wheelbarrow 10 about the shoveling edge 25 (in direction of arrow 59) to cause material within the storage unit to be unloaded.

According to a specific embodiment (shown in FIG. 3B by a dashed line), a barrier wall 29 is provided within the storage unit 20 adapted to prevent material loaded therein from falling out of the wheelbarrow 10 at the upright position of FIG. 3C. The barrier wall 29 may be a removable article securely received within slots formed in the side walls 28 and base 22, or it may be hingidly secured to the bottom base 22 and rotated about the bottom 22 of the storage unit 20 when not in use, e.g. during loading of the wheelbarrow 10.

Turning to FIGS. 4A and 4B, the wheel assembly 30 is attached to the storage unit 20 via its axle 33. In assembly the axle 33 is inserted through bearings 23a, with the support members 23b acting on the axle 33 to prevent it from buckling upwards and for supporting the base wall 22 of the storage unit 20. Once the axle 33 is inserted, the wheels 32 are mounted on each side of the axle to form the wheel assembly 30. According to a specific embodiment (not shown), the axle is formed of two sections, each having a distal end and a proximal end. The proximal ends of the axle sections are adapted to be connected to each other using a snap/screwing engagement, the distal ends of the axle sections being adapted for mounting thereon of the wheels 32. According to a specific design variation (not shown), the axle 33 is integrally formed with the storage unit 20 and the wheels are rotatably mounted thereon.

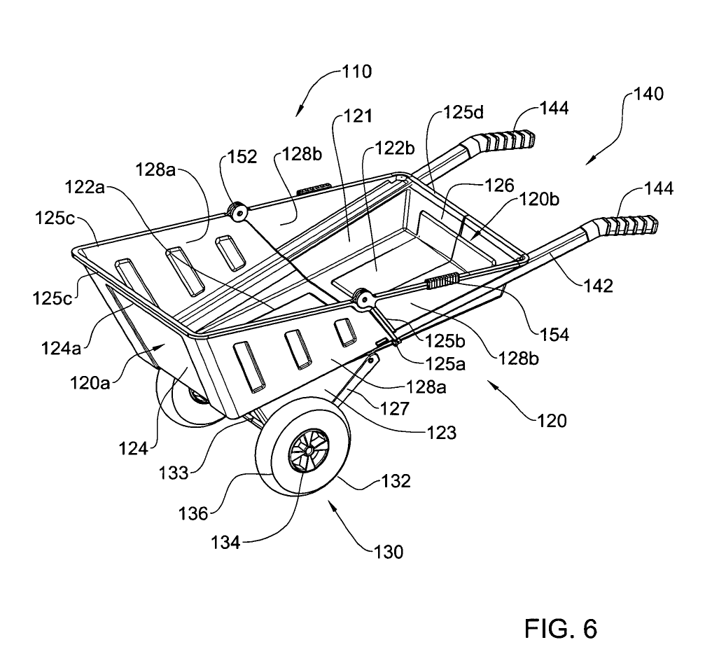

It is appreciated that the wheelbarrow 10 is typically a single mold article (‘mono-block’). However component injection may be used for some particular portions, e.g. hand grips, for obtaining reinforced portions of the structure and for a multi-colored article. Referring to FIG. 6, there is illustrated an isometric view of another embodiment of the wheelbarrow according to the present invention, generally designated 110, and comprising a storage unit 120, a wheel assembly 130 attached to the storage unit 120, and a handling portion 140.

The storage unit 120 is formed of two portions 120a and 120b, the first portion 120a having a bottom wall 122a, a front wall 124, and two side walls 128a, and the second portion 120b having a bottom wall 122b, a rear wall 126, and two side walls 128b, both portions defining a storage space 121 therein. The bottom walls 122a and 122b are substantially flush at the position illustrated in FIG. 6.

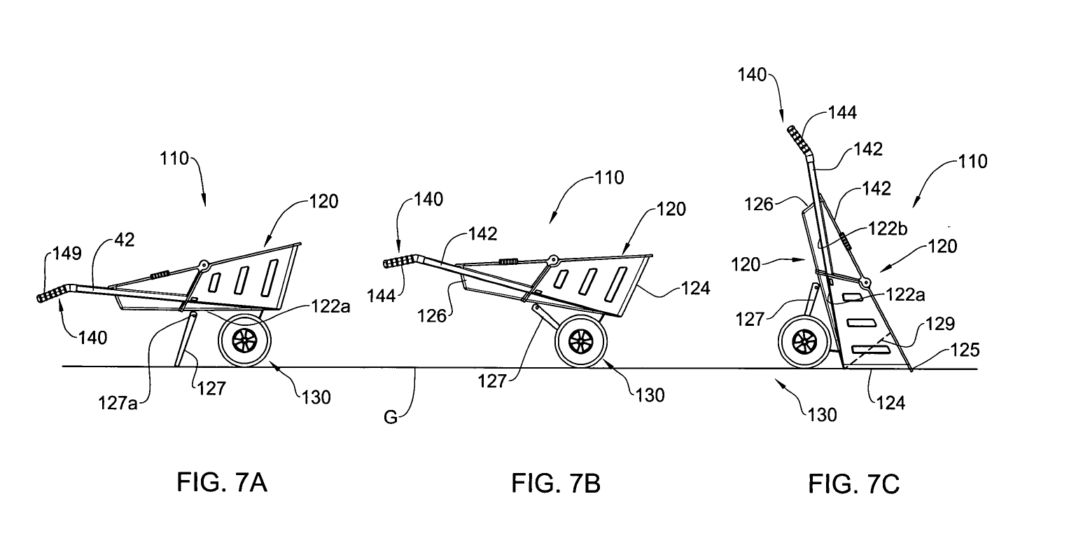

The walls 124, 126, 128a and 128b taper slightly outwardly from the bottom walls 122a and 122b. The tapering of the walls may also facilitate nesting of one storage unit 120 within the storage space 121 of another storage unit 120, allowing convenient stacking of storage units one on top of the other. A top end 124a of the front wall 124 is formed with a shoveling edge 125 fitted for scooping/shoveling of material from the ground as will be explained in detail with respect to FIG. 7C.

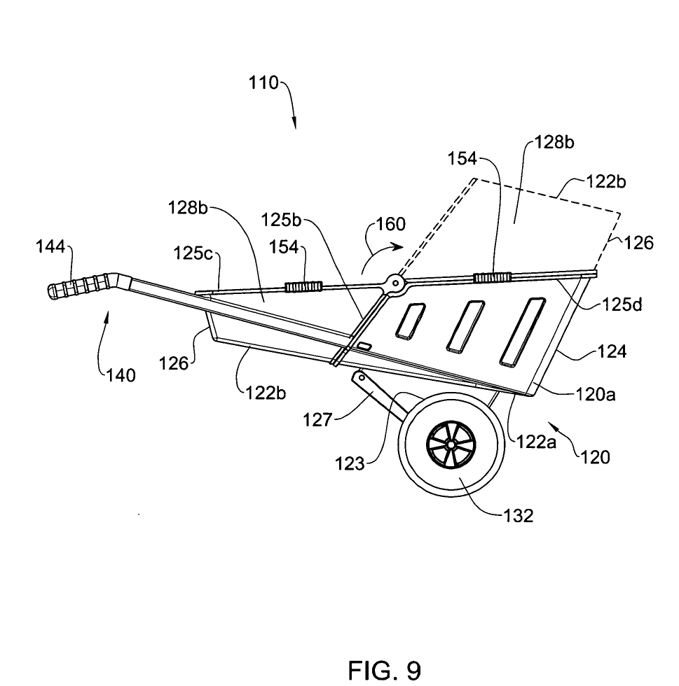

The portions 120a, 120b of the storage unit 120 are pivotally articulated to each other at 152, the purpose of which will be explained in detail later with respect to FIG. 9.

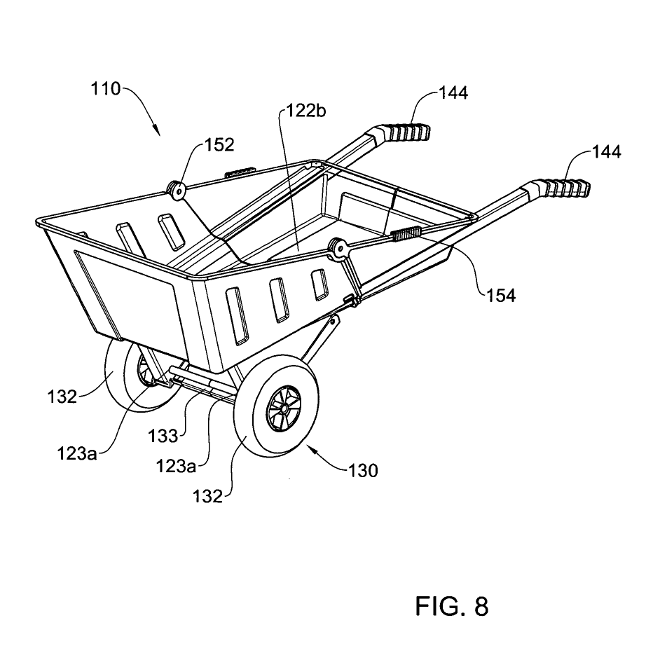

The wheel assembly 130 comprises two wheels 132 mounted on a common axle 133 (similar to the embodiment shown FIG. 4A), each wheel being formed of a hard core 134 and a softer lining 136. The common axle 133 is mounted on the storage unit as will be explained with respect to FIG. 8.

The handling portion 140 is in the form of two arm extensions 142 extending upwardly at an angle from the first portion 120a of the storage unit 120, serving as handles for the wheelbarrow 110. Each extension 142 is formed at its distal end with a gripping portion in the form of gripping handle 144.

Turning to FIGS. 7A to 7C, the wheelbarrow 110 is shown at its ‘stationary’, ‘transport’ and ‘L’ (up-right) positions, respectively. At the ‘stationary’ position, the wheelbarrow 110 rests on the ground G upon the wheel assembly 130 and on a foldable support leg 127 extending from the first portion 120a of the storage unit 120, wherein a load may rest securely within the storage unit 120. The support leg 127 is hingedly articulated to the bottom of the first portion 120a and is adapted to be rotated about an axis of a hinge 127a to be deployed when the wheelbarrow 110 is at the ‘stationary’ position. The support leg 127 is pivotally secured to the hinge 127a such that when the wheelbarrow 110 is brought to the ‘stationary’ position, gravitational forces pull it down, automatically deploying it. However, the arrangement my be such that the support leg 127 is retained at a first discrete position where it is collapsed and prevented from dangling below the wheelbarrow 110, so as not interfere with manipulating thereof (FIGS. 7B and 7C), or at a second discrete position where it is deployed as in FIG. 7A.

At the ‘transport’ position (FIG. 7B), the support leg 127 is disengaged from the ground G and the wheelbarrow is lifted by gripping the handles 44, allowing maneuvering of the wheelbarrow 10 over the ground G upon the wheel assembly 30 alone. In the ‘transport’ position, most of the load of the wheelbarrow 110 and its contents is distributed over the first portion 120a and supported by the wheel assembly 130 rather than by the operator, allowing carrying great amounts of material.

In the upright, so-called ‘L’ position, the wheelbarrow 110 rests on the ground G supported by the wheel assembly 130 and front wall 124. The tapering angle of the front wall 124 with respect to the bottom walls 122a and 122b is designed such that at the ‘L’ position, it is essentially flush against the ground G.

The shoveling edge 125 formed at the top end 124a of the front wall 124 allows scooping a substantial amount of material (not shown) into the wheelbarrow 110 by pushing the wheelbarrow 110 forward, for example against a heap of material. When loading the wheelbarrow 110 with material, the pushing forwards movement may be aided by the operator presenting his foot either on the wheel assembly 130.

According to a specific embodiment a partial barrier wall 129 (FIG. 7C) is provided within the storage unit 120 between at a fore end of the first portion 120a, adapted to prevent material loaded therein from falling out of the wheelbarrow 110, similar to the arrangement shown FIG. 3C. The barrier wall 129 may be removed or rotated about the bottom 122 of the storage unit 120 during loading of the wheelbarrow 110.

Turning to FIG. 8, the wheel assembly 130 is attached to the storage unit 120 via its axle 133. In assembly the axle 133 is inserted through bearings 123a. Once the axle 133 is inserted, the wheels 132 are mounted on each side of the axle to form the wheel assembly 130. According to a specific embodiment (not shown), the axle is formed of two sections, each having a distal end and a proximal end. The proximal ends of the axle sections are adapted to be connected to each other using a snap/screwing engagement, the distal ends of the axle sections being adapted for mounting thereon of the wheels. According to another design variation (not shown), the axle is integrally formed with the storage unit 120.

Turning to FIG. 9, and with reference to FIG. 6, the storage unit 120 may assume at least one of two positions: a ‘wheelbarrow’ position and a ‘container’ position. In the ‘wheelbarrow’ position depicted in FIGS. 6 to 8, the two portions 120a and 120b are oriented such that the bottom walls 122a, 122b of the portions form a uniform bottom surface 122, surrounded by the front wall 124, rear wall 126 and side walls 128a and 128b of the portions. The portions 120a, 120b are in contact via a rim 125a, 125b of the first and second portion respectively. In this position, as previously described, the storage unit 120 serves as a storage unit of a wheelbarrow 110.

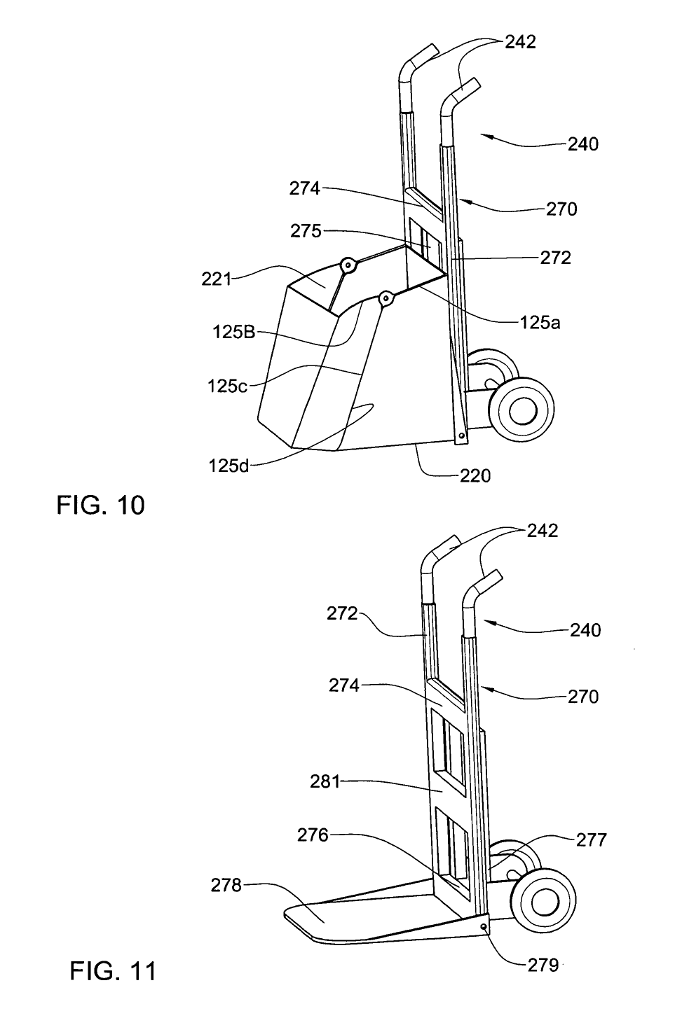

At the ‘container’ position (FIGS. 9 and 10), the second portion 120b is rotated about the hinge 127a in the direction of arrow 160 (into the position illustrated by dashed lines in FIG. 9 and as seen in FIG. 10) such that the rear wall 126 thereof becomes flush with the front wall 126 of the first portion 120b to form a uniform surface. The portions 120a, 120b are connected through the rims 125c, 125d. In order to secure the two portions, latches 154 are provided along the rim 125d adapted to connect the latter rim to the rip 125c of the first portion 120a. the rims 125c, 125d of the portions 120a, 120b may be fitted with a sealing arrangement, e.g. a resilient rim or the like, such that at the ‘container’ position loose material and liquids may be contained in the confined space 221 (FIG. 10). In this position, when the wheelbarrow 110 is positioned in the upright ‘L’ position, it may be top loaded with any desired load since the rims 125a, 125b define an opening directed upwards.

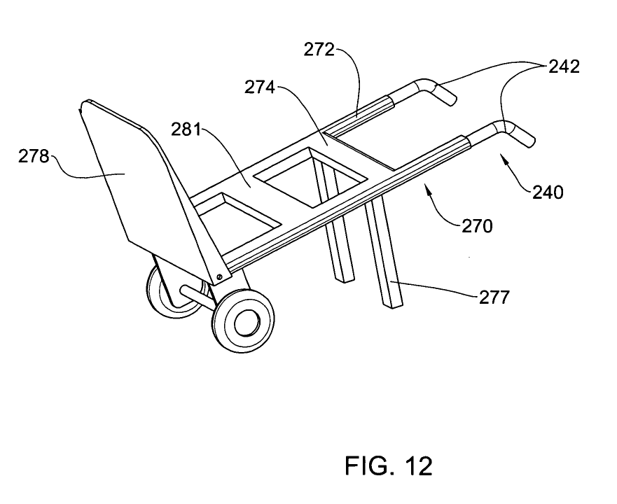

Turning now to FIGS. 10 to 12, a similar embodiment of a wheelbarrow 210 according to the present invention is shown, comprising a support frame 270 constituted by two longitudinal bars 272, a top transverse bar 274 and a bottom transverse bar 276. The support frame further comprises two support legs 227 (shown FIG. 12) similar to the support legs 127 of the embodiment illustrated in connection with FIGS. 7A to 7C, for supporting the wheelbarrow at the ‘stationary position’.

The wheelbarrow 210 further comprises a pivotable platform 278 which, secured at a bottom of the support frame 270, will be discussed in details later.

The support frame 270 forms the skeleton of the wheelbarrow 210 and the handling portion 240 and wheel assembly 230 are attached thereon to form a part thereof. The storage unit 220 is constructed similarly to that disclosed in the embodiment of FIGS. 7 to 9 and operates essentially the same way as with regards to the storage unit 120 previously described. The storage unit 220 is fitted for detachably attaching to the support frame 270. At the attached position (FIG. 10) it rests over the pivotable platform 278 and is attached to a secure latch 281 (FIG. 11) for the purpose of which the storage unit 220 is provided with two hooks (not shown) allowing it to be easily attached and detached, though in a fast and secure manner.

The storage unit 220 may be detached from the support frame 270 so as to create a portable storage unit. For this purpose, the storage unit 220 is formed with a carrying handle 225 (FIG. 10) allowing an operator to easily carry the storage unit 220 from one location to another.

The handling portion 240 of the wheelbarrow 210 comprises two angled handles 242 which are positioned within the longitudinal bars 272 which are hollow so as to form a telescopic member. Thus, the handles 242 may be extended when the storage unit 220 is in the ‘wheelbarrow’ position and retracted when the storage unit 220 is in the ‘container’ position.

The pivotal platform 278 is articulated to the support frame 270 by a hinge 279. In the ‘container’ position, the platform 278 may assume a position substantially parallel to the longitudinal bars 272, being essentially flush with the support frame 270. Alternatively, the platform 278 may assume a position perpendicular to the longitudinal bars 272 (shown FIG. 11) so as to support the weight of the storage unit 220. When the storage unit 220 is removed from the support frame 270, the platform 278 may be extended as shown in FIG. 11 to transform the wheelbarrow 210 into a hand truck.

Those skilled in the art to which this invention pertains will readily appreciate that numerous changes, variations, and modifications can be made without departing from the scope of the invention, mutatis mutandis.

1. According to the present invention there is provided a wheelbarrow comprising a storage unit, a wheel assembly associated with said storage unit and having at least one wheel of a predetermined diameter, and at least one gripping member, also associated with said storage unit, and adapted for manipulation of said wheelbarrow by an operator; said storage unit is formed with at least one wall extending along a direction tangent to said at least one wheel whereby said wheelbarrow is adapted to assume a first, ‘transport’ position in which said wheelbarrow is transportable about upon said wheel assembly, and a second, ‘L’ position in which said wheelbarrow has an essentially vertical orientation with respect to a surface in which said wheelbarrow is supported by said wheel assembly and said wall.

2. A wheelbarrow according to claim 1, wherein said storage unit is further formed with a bottom extension adapted to provide support for the wheelbarrow allowing it to assume a third, ‘stationary’ position.

3. A wheelbarrow according to claim 2, wherein in said stationary position, said wheelbarrow is supportable by an operator by said at least one gripping element.

4. A wheelbarrow according to claim 1, wherein said storage unit is formed with a bottom, front and side walls, and is designed so as to allow nesting of one wheelbarrow within a similar corresponding wheelbarrow, to thereby allow stacking of a plurality of wheelbarrows one on top of the other in a compact manner.

5. A wheelbarrow according to claim 1, wherein said storage unit further comprises a rim with a shoveling edge.

6. A wheelbarrow according to claim 5, wherein in said ‘L’ position, said shoveling edge is in contact with said surface.

7. A wheelbarrow according to claim 1, wherein said storage unit further comprises a barrier wall adapted to prevent scooped material from falling out of the storage unit when said wheelbarrow is in said ‘L’ position.

8. A wheelbarrow according to claim 1, wherein the bottom end of said storage unit is formed with a foot-rest adapted to allow an operator, when said wheelbarrow is in said ‘L’ position, to apply pressure using his foot in order to scoop material into said storage unit.

9. A wheelbarrow according to claim 8, wherein said foot rest is constituted by said wheel assembly.

10. A wheelbarrow according to claim 1, wherein said storage unit is formed of a first portion and a second portion, articulated to each other via a hinge, each portion having a bottom wall, a front wall and at least one side wall extending from said bottom wall.

11. A wheelbarrow according to claim 10, wherein said storage unit is adapted to assume a first storage position, i.e. ‘container position’, and a second storage position, i.e. ‘wheelbarrow’ position.

12. A wheelbarrow according to claim 11, wherein in said container position, the front wall of said first portion is essentially flush against the front wall of said second portion to form a uniform front surface, and the bottom walls of each of the portions being spaced apart by said at least one side wall of each portion, to form a container.

13. A wheelbarrow according to claim 12, wherein in said ‘L’ position, said uniform front surface is adapted to support the weight of a material stored within said storage unit.

14. A wheelbarrow according to claim 12, said container is open at the end opposite said uniform front surface so as to allow top loading of material therein when said wheelbarrow is in said ‘L’ position.

15. A wheelbarrow according to claim 11, wherein said storage unit comprises a securing mechanism adapted for securely connecting said first portion to said second portion in order to prevent said container from opening by rotation of one of said portions about the hinge.

16. A wheelbarrow according to claim 15, wherein the rim of each portion of said storage unit is formed with a rail and said securing mechanism is slidable along said rail.

17. A wheelbarrow according to claim 11, wherein in said wheelbarrow position, the bottom wall of said first portion is essentially flush against the bottom wall of said second portion to form a uniform bottom surface to form an open wheelbarrow storage unit surrounded by the front and side walls of each portion.

18. A wheelbarrow according to claim 17, wherein in said ‘transport’ position, said uniform bottom surface is adapted to support the weight of a material loaded onto said storage unit.

19. A wheelbarrow according to claim 1, wherein said wheelbarrow further comprises a support frame formed of at least one longitudinal bar and at least one transverse bar, adapted to provide support for said storage unit.

20. A wheelbarrow according to claim 19, wherein said longitudinal bar is telescopic.

21. A wheelbarrow according to claim 19, wherein said storage unit is detachably attachable to/from said support frame.

22. A wheelbarrow according to claim 19, wherein said support frame also comprise a back support hingedly articulated to said support frame.

23. A wheelbarrow according to claim 22, wherein said back support is adapted to assume a closed position in which it extends essentially in the direction of the longitudinal bars and an open position in which it extends perpendicularly to said frame.

24. A wheelbarrow according to claim 23, wherein said back support is freely attached to said transverse bar so as to automatically assume its position be gravitational force.

25. A wheelbarrow according to claim 22, wherein said back support is in the form of a platform adapted to be tilted to become essentially perpendicular to said frame in order to provide support for said storage unit and/or to various items positioned thereon, to be used as a hand truck.

26. A wheelbarrow according to claim 1, wherein said wheelbarrow comprises two gripping elements adapted for the hands of an operator, adapted for gripping thereof in both said first position of the wheelbarrow and said second gripping surface being adapted for gripping in said second ‘L’ position.

27. A wheelbarrow according to claim 1, wherein said wheelbarrow excluding said wheel assembly, is made of plastic and formed as a single injection molding element.

28. A storage unit for a wheelbarrow comprising a first and a second storage unit portions, each portion comprising a bottom wall, a front wall and two side walls, said second portion being articulated to said first portion so as to allow rotation thereof about said first portion about an axis, said storage unit having at least two positions:
a. a container position in which the front wall of said first portion is essentially flush against the front wall of said second portion to form a uniform front surface, the bottom walls of each of the portions being spaced apart by said side walls of each portion to form a container;
b. a wheelbarrow position in which the bottom wall of said first portion is essentially flush against the bottom wall of said second portion to form a uniform bottom surface, the front walls of each of the portions being spaced apart by said side walls of each portion to form wheelbarrow platform.

29. A wheelbarrow made of a single injection molding element, said wheelbarrow comprising a storage unit, at least one gripping means and an attachment port for a wheel assembly comprising at least one wheel; said storage unit being formed with at least one wall extending along a direction tangent to said at least one wheel such whereby said wheelbarrow is adapted to assume a first ‘transport’ position in which said wheelbarrow is transportable about upon said wheel assembly, and a second position in which said wheelbarrow has an essentially vertical ‘L’ position in which at least a portion of said wall and said at least one wheel rest one a single planar surface.
